(19) United States
(12) Patent Application Publication
(10) Pub. No.: US 2005/0243208 A1
(43) Pub. Date: Nov. 3, 2005

(54) Television set

(76) Inventor: Hao-Chang Huang, Taoyuan City (TW)

Correspondence Address: RABIN & Berdo, PC, 1101 14TH STREET, NW, SUITE 500, WASHINGTON, DC, 20005, US

(21) Appl. No.: 11/102,731

(22) Filed: Apr. 11, 2005

(30) Foreign Application Priority Data
Apr. 28, 2004 (TW) 93111914

(51) Int. Cl. H04N 5/64

(52) U.S. Cl. 348/553; 348/554

(57) ABSTRACT

A TV set includes an extended module and a motherboard. The extended module decodes and demodulates an input signal and outputs a baseband audio/video signal accordingly. The motherboard includes a universal interface, a signal processing unit and a microprocessor. The universal interface is for coupling with the extended module to receive the baseband audio/video signal. The signal processing unit is for coupling with the universal interface, doing audio/video processing on the baseband audio/video signal, and outputting the processed signal. The microprocessor is for controlling the signal processing unit and the extended module via the universal interface.

This application claims the benefit of Taiwan application Serial No. 93111914, filed Apr. 28, 2004, the subject matter of which is incorporated herein by reference.

### BACKGROUND OF THE INVENTION

1. Field of the Invention

The invention relates in general to a television (TV) set, and more particularly to a TV set, which modularizes the decoding function and the demodulating function of the motherboard and separates the module formed thereby from the motherboard.

2. Description of the Related Art

Referring to FIG. 1A, a circuit structure diagram of a motherboard according to a conventional TV set is shown. The motherboard 100 includes a decoding/demodulating unit 110, a multiplexer 120, a signal processing unit 130 and a microprocessor 140. When the TV set receives broadcasting signals Sc from a satellite channel, a cable TV or a wireless TV, the decoding/demodulating unit 110 is controlled by the microprocessor 140 to decode and demodulate the broadcasting signal Sc, and then output baseband audio/video signals Scb accordingly. When the TV set receives a number of baseband audio/video signals Sb outputted by a DVD optical drive or a digital camera, the microprocessor 140 controls the multiplexer 120 to select and output the desired baseband audio/video signals Sb to the signal processing unit 130. The signal processing unit 130 is controlled by the microprocessor 140 to do audio/video processing, such as Y-C separation and scaling for instance, on the baseband audio/video signals Scb or Sb, and then output the processed signals to be displayed on the display 150.

The broadcasting signals Sc including cable TV signals, wireless TV signals and radio frequency (RF) input signals, and the baseband audio/video signals Sb including composite-video signals, S-video signals and component-video signals YCbCr, according to various areas and countries, are further classified as US analog signals of an NTSC system, European analog signals of a PAL system, US digital signals of a ATSC system and European digital signals of a DVB system.

A common problem to a TV set user is that an analog TV set of an NTSC system can only receive analog broadcasting programs. If the user wants to upgrade the TV set to receive digital broadcasting programs of an ATSC system or other European broadcasting programs of PAL and DVB systems, the motherboard 100 needs to be replaced with a new one.

When upgrading a TV set, a conventional method is to use a set-top box for the user to view digital broadcasting programs, or renew the TV-interface to receive broadcasting signals and audio/video signals of different systems. Referring to FIG. 1B, a circuit structure diagram of the coupling between a digital TV mainframe and an extended system card according to the Taiwan Patent No. 541836 is shown. The mainframe 160 reserves basic applications, operating systems, apparatus drivers, and hardware required for basic digital TV receiving/playing functions. By the definition and design of a universal extended interface 170, the application programs originally executed in the mainframe 160 are shifted to be executed in the extended system card 180. The mainframe 160 can be upgraded to execute different application programs by renewing the extended system card 180. However, the digital TV disclosed in the above-mentioned patent can only be extended by renewing the application program system, but cannot be extended and upgraded according to different broadcasting systems such as NTSC, PAL, ATSC and DVB to meet user's various requirements.

### SUMMARY OF THE INVENTION

It is therefore an object of the invention to provide a TV set which separates the decoding and demodulating function and the baseband audio/video signal switching function from the motherboard to form an I/O module. The motherboard can be incorporated with various I/O modules according to user's requirement to receive the input broadcasting signals and baseband audio/video signals of different systems, not only enhancing the system upgradeability of the TV set, but also improving production management and reducing the stocks.

The invention achieves the above-identified object by providing a TV set for receiving an input signal. The TV set includes an extended module and a motherboard. The extended module decodes and demodulates the inputted signal and then outputs a baseband audio/video signal. The motherboard includes a universal interface, a signal processing unit and a microprocessor. The universal interface, coupling with the extended module, is for receiving the baseband audio/video signal. The signal processing unit, coupling with the universal interface, is for doing audio/video processing on the baseband audio/video signal and then outputting the processed signal. The microprocessor is for controlling the signal processing unit and the extended module via the universal interface. The input signal includes a broadcasting signal and a number of baseband audio/video signals. The extended module includes a decoding/demodulating unit and a multiplexer. The decoding/demodulating unit decodes and demodulates the broadcasting signal. The multiplexer selects a part of the baseband audio/video signal for the output.

The microprocessor directly controls the decoding/demodulating unit and the multiplexer via the universal interface. The extended module includes a controller, and the microprocessor controls the controller via the universal interface to indirectly control the decoding/demodulating unit and the multiplexer. The universal interface includes a number of European signal pins, a number of US signal pins and a number of Europe/US channel common pins. In case that the input signal is an NTSC audio/video signal, the decoding/demodulating unit includes a US audio/video decoder, and the extended module is coupled to the signal processing unit via the US signal pins, and a part of Europe/US channel common pins of the universal interface. In case that the input signal is a PAL audio/video signal, the decoding/demodulating unit includes a European audio/video decoder, and the extended module is coupled to the signal processing unit via the European signal pins and a part of Europe/US channel common pins of the universal interface.

In case that the input signal is an ATSC audio/video signal, the decoding/demodulating unit includes a US audio/video decoder and a digital analog converter, and the extended module is coupled to the signal processing unit via the US signal pins and a part of Europe/US spec channel common pins of the universal interface. In case that the input signal is a DVB system signal, the decoding/demodulating unit includes an European audio/video decoder and a digital analog converter, and the extended module is coupled to the signal processing unit via the European signal pins and a part of Europe/US spec channel common pins of the universal interface. The extended module includes a DVD decoder for decoding the DVD audio/video signal. The microprocessor uses the detecting signal pins of the universal interface to detect the DVD decoder and uses the controlling signal pins of the universal interface to control the DVD decoder, not only enhancing the system upgradeability of the TV set, but also improving production management and reducing the stocks.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a circuit structure diagram of a motherboard according to a conventional TV set;

FIG. 1B is a circuit structure diagram of the coupling between a digital TV mainframe and an extended system card according to a Taiwan Patent No. 541836;

FIG. 2A is a circuit structure diagram of a TV set according to a preferred embodiment of the invention;

FIG. 2B is a circuit structure diagram showing the coupling in FIG. 2A between an I/O module receiving an NTSC audio/video signal and a motherboard;

FIG. 2C is a circuit structure diagram showing the coupling in FIG. 2A between an I/O module receiving a PAL audio/video signal and a motherboard;

FIG. 2D is a circuit structure diagram showing the coupling in FIG. 2A between an I/O module receiving an ATSC audio/video signal and a motherboard; and

FIG. 2E is a circuit structure diagram showing the coupling in FIG. 2A between an I/O module receiving a DVB audio/video signal and a motherboard.

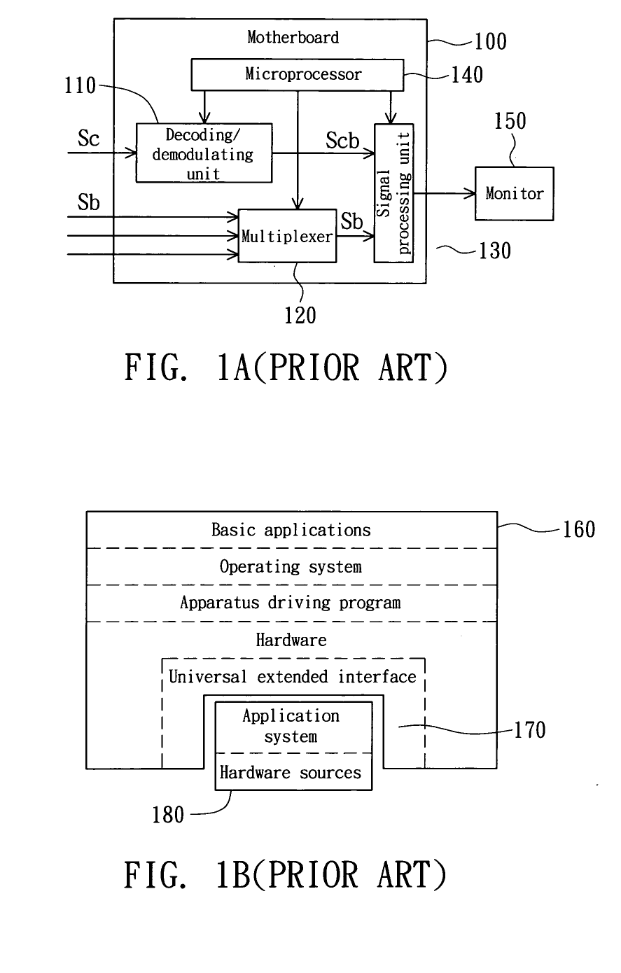

### DETAILED DESCRIPTION OF THE INVENTION

The main feature of the invention lies in modularizing the functions of decoding and demodulating the broadcasting signal and the function of switching the baseband audio/video signal in the motherboard and then separating the above functions from the motherboard to form an independent input/output (I/O) module. So the motherboard, according to user's requirements, can assemble various I/O modules to receive the input broadcasting signals and baseband audio/video signals of different systems, not only enhancing system upgradeability of the TV set, but also conducing to production management and reducing the stocks.

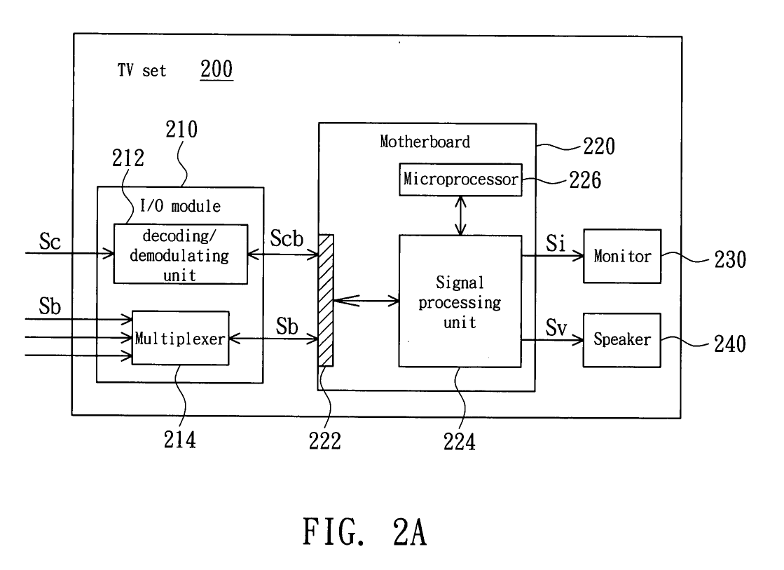

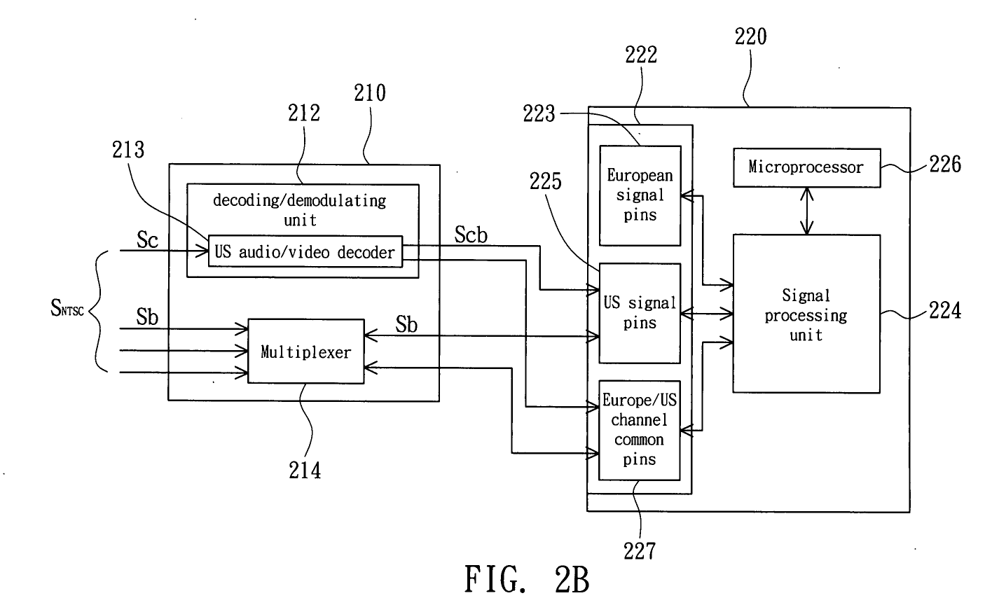

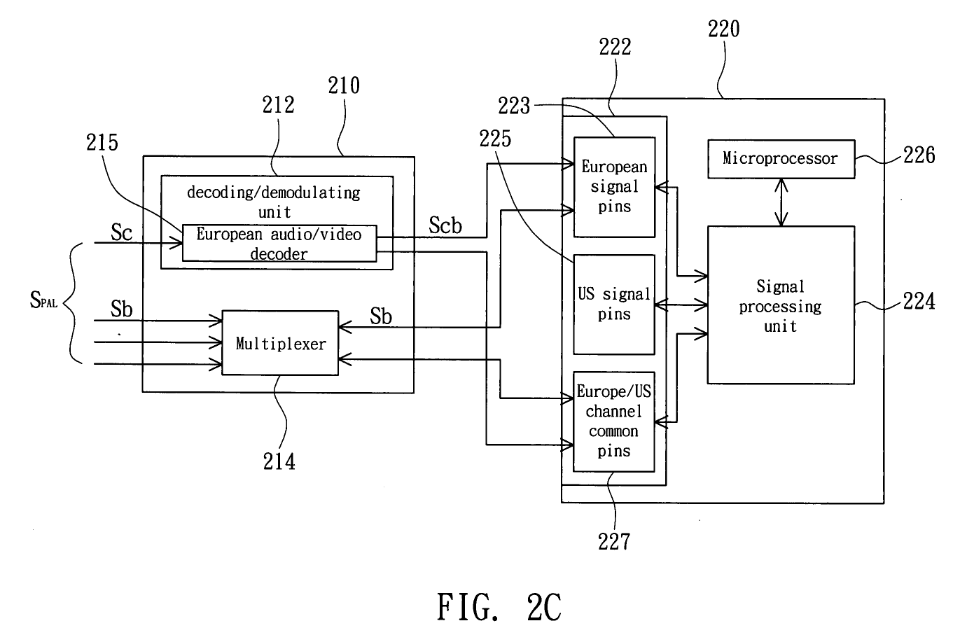

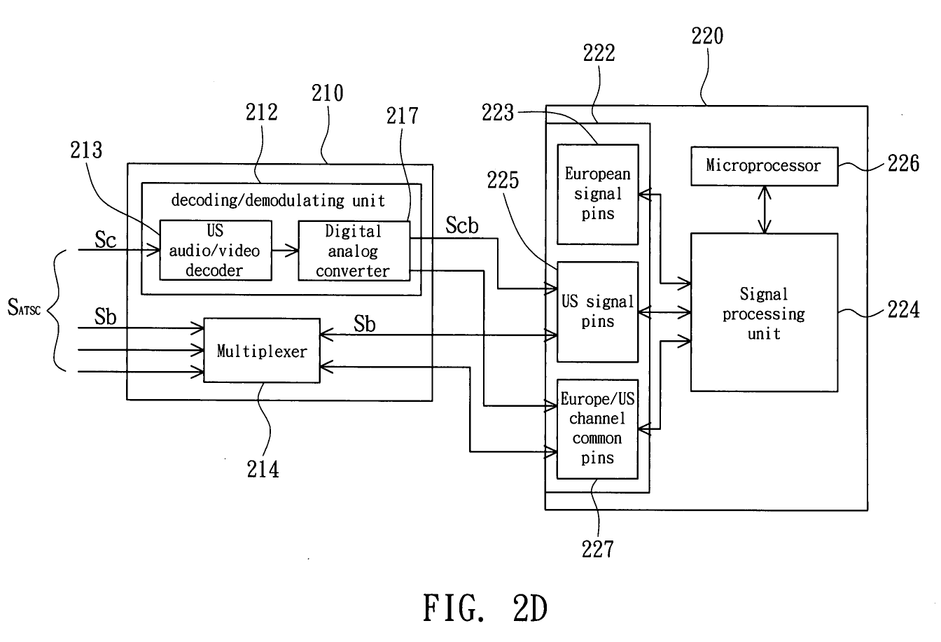

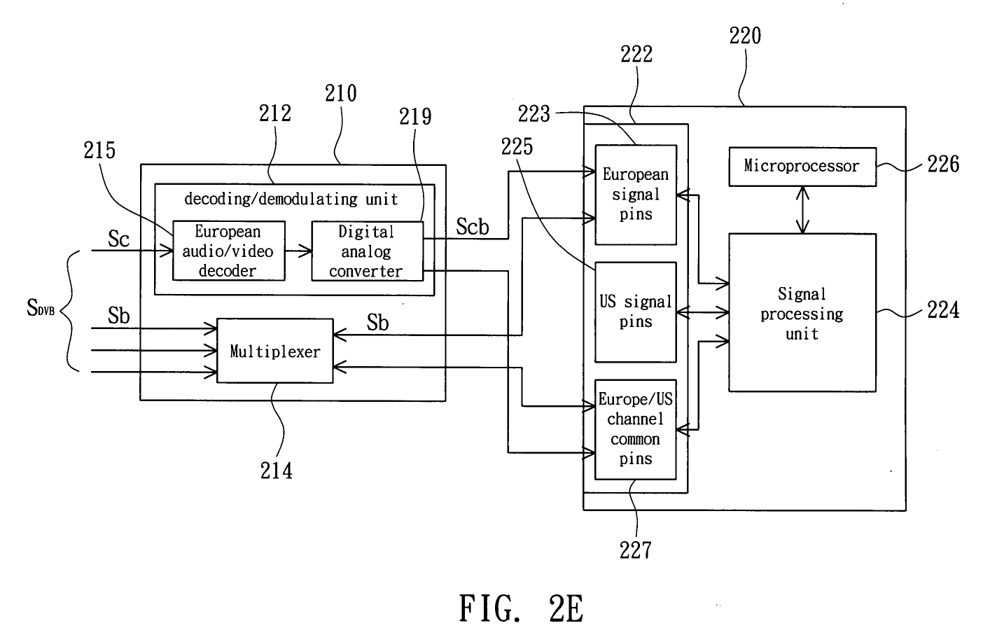

Referring to FIG. 2A, a circuit structure diagram of a TV set according to a preferred embodiment of the invention is shown. The TV set 200 is for receiving input signals such as broadcasting signals Sc and baseband audio/video signals Sb and so on. The broadcasting signals Sc include satellite signals, cable signals, radio signals and RF signals. The baseband audio/video signals Sb include S-video signals, composite-video signals and component-video signals and so on. The TV set 200 includes an input/output (I/O) module 210, a motherboard 220, a display 230 and a speaker 240. The I/O module 210, which receives power supplied from the motherboard 220, includes a decoding/demodulating unit 212 and a multiplexer 214. The decoding/demodulating unit 212 decodes and demodulates the broadcasting signals Sc, and outputs the baseband audio/video signals Scb accordingly. The multiplexer 214 selects a part of baseband audio/video signals Sb and then outputs the selected signals.

Besides, the motherboard 220 includes a universal interface 222, a signal processing unit 224 and a microprocessor 226. The universal interface 222 is for coupling with the I/O module 210 to receive the baseband audio/video signals Scb and Sb. The signal processing unit 224 is for coupling with the universal interface 222 and doing audio/video processing on the baseband audio/video signals Scb and Sb, and then respectively outputting the video signals Si and the audio signals Sv to the display 230 and the speaker 240. The microprocessor 226 controls the signal processing unit 224 and directly detects and controls the decoding/demodulating unit 212 and the multiplexer 214 of the I/O module 210 via pins of the universal interface 222. The motherboard 220, coupled with the I/O module 210 having a controller, can detect the status of the I/O module through the controller and indirectly control the decoding/demodulating unit 212 and the multiplexer 214 via the universal interface by polling method.

The feature of the invention lies in modularizing the functions of decoding and demodulating the broadcasting signals Sc and the function of switching the baseband audio/video signal Sb in the motherboard 220 and then separating the above functions from the motherboard to form an independent input/output (I/O) module 210. The signal processing unit 224 only reserves the basic video, image and audio processing of the baseband audio/video signals Scb and Sb. With the design of the pins on the universal interface 222, the motherboard 220 can be incorporated with various types of I/O modules according to users' requirements to receive the broadcasting signals Sc and the baseband audio/video signals Sb of different systems, thereby enhancing the system upgradeability of the TV set 200.

Referring to Table 1, the universal interface 222 has 62 signal and power pins. Pins 1˜5, 22˜25 and 43˜44 are for transmitting teletext related European TV signals. Pins 6 and 27 are for transmitting European detecting signals SCART. Pins 7˜8, 28˜29, 48 and 53˜54 are for transmitting control signals from the microprocessor 226 to control the I/O module 210, for example, 12C USDA and USDL signals and UART signals. Pins 9˜11 and 30˜32 are for transmitting S-video signals SVHS. Pins 12 and 33˜34 are for transmitting composite-video signals CVBS. Pins 45˜47 are TV-out signal pins. Pins 13, 26, 49˜52 and 57 are power pins. Pins 14, 15˜17, 35˜38 and 58 are for transmitting US audio signals. Pins 18˜20, 39˜41 and 59˜61 are for transmitting component-video signals YUV. Pins 21, 42 and 62 are Europe/US audio signal common pins.

Besides, pins 55˜56 are for transmitting the detecting signals ID_1 and ID_2 to detect the attributes or equipment of the I/O module 210. For example, ID_1=‘1’, ID_2=‘0’, represents that the I/O module 210 is equipped with a DVD decoder (or a DVD player). In short, the above 62 pins include European signal pins such as teletext signal pins and SCART signal pins, US signal pins such as audio signal pins, and Europe/US channel common pins such as video signal pins, component-video signal pins, controlling signal pins, detecting signal pins, power pins and audio signal pins.

TABLE 1

| Pins | Signal Name | Signal Attribute |
|---|---|---|
| 1 | Teletext_RGB_B (6) | European |
| | | Teletext signal |
| 2 | Teletext_RGB_G (6) | European |
| | | Teletext signal |
| 3 | Teletext_RGB_R (6) | European |
| | | Teletext signal |
| 4 | Teletext_fast_blanking | European |
| | | Teletext signal |
| 5 | Teletext_start | European |
| | | Teletext signal |
| 6 | SCART_aspect_ratio_1 | European |
| | | detecting signal |
| | | SCART |
| 7 | DAC_RST (1) | I²C reset signal |
| 8 | TX_232 | UART signal |
| 9 | SVHS_2_C (3) | S-video signal |
| 10 | SVHS_1_Return (3) | S-video signal |
| 11 | SVHS_1_Y (3) | S-video signal |
| 12 | CVBS_1_Signal (2) | composite- |
| | | video signal |
| 13 | GND_1_of_(3) | grounded |
| | | power line |
| 14 | Audio_Center_Gnd_{—} | US audio |
| | Gnd (2) | Signal |
| 15 | Audio_to_earphone_for_{—} | US audio |
| | subpicture_L (2) | Signal |
| 16 | Audio_Woofer_Gnd_{—} | US audio |
| | woofer (2) | Signal |
| 17 | Audio_Rear_L_R_Gnd_{—} | US audio |
| | of_R (3) | Signal |
| 18 | YUV_1_Pr (6) | component- |
| | | video signal |
| 19 | YUV_1_Pb (6) | component- |
| | | video signal |
| 20 | YUV_1_Y (6) | component- |
| | | video signal |
| 21 | Audio_Front_L_R_Gnd_{—} | Europe/US |
| | of_R (3) | audio signal |
| | | common pins |
| 22 | Teletext_VS | European |
| | | Teletext signal |
| 23 | Teletext_RGB_B_{—} | European |
| | Return (6) | Teletext signal |
| 24 | Teletext_RGB_G_{—} | European |
| | Return (6) | Teletext signal |
| 25 | Teletext_RGB_R_{—} | European |
| | Return (6) | Teletext signal |
| 26 | GND_2_of_(3) | grounded |
| | | power line |
| 27 | SCART_mode_det_1 | European |
| | | detecting signal |
| | | SCART |
| 28 | RESET_I_O_Module | I/O module |
| | | reset signal |
| 29 | RX_232 | UART signal |
| 30 | SVHS_2_Return (3) | S-video signal |
| 31 | SVHS_2_Y (3) | S-video signal |
| 32 | SVHS_1_C (3) | S-video signal |
| 33 | CVBS_1_Return (2) | composite- |
| | | video signal |
| 34 | CVBS_2_Signal (1) | composite- |
| | | video signal |
| 35 | Audio_Center_Gnd_{—} | US |
| | signal (2) | audio signal |
| 36 | Audio_to_earphone_for_{—} | US |
| | subpicture_R (2) | audio signal |
| 37 | Audio_Woofer_Gnd_{—} | US |
| | gnd (2) | audio signal |
| 38 | Audio_Rear_L_R_Gnd_{—} | US |
| | of_gnd (3) | audio signal |
| 39 | YUV_1_Pr_Return (6) | component- |
| | | video signal |
| 40 | YUV_1_Pb_Return (6) | component- |
| | | video signal |
| 41 | YUV_1_Y_Return (6) | component- |
| | | video signal |
| 42 | Audio_Front_L_R_Gnd_{—} | Europe/US |
| | of_Gnd (3) | audio signal |
| | | common pins |
| 43 | Teletext_HS | European |
| | | Teletext |
| | | Signal |
| 44 | Teletext_Hs_Vs_return | European |
| | | Teletext |
| | | Signal |
| 45 | TV_out | TV-OUT signal |
| 46 | TV_R | TV-OUT |
| | | signal |
| 47 | TV_L | TV-OUT signal |
| 48 | Audio_Mute | mute |
| | | controlling |
| | | signal |
| 49 | 12V_a (2) | 12 V power line |
| 50 | 12V_b (2) | 12 V power line |
| 51 | 5V_a (2) | 5 V power line |
| 52 | 5V_b (2) | 5 V power line |
| 53 | USDA | I²C SDA signal |
| 54 | USCL | I²C SCL signal |
| 55 | ID_1 | the detecting |
| | | signal |
| 56 | ID_2 | the detecting |
| | | signal |
| 57 | GND_3_of_(3) | grounded |
| | | power line |
| 58 | Audio_Rear_L_R_Gnd_{—} | US |
| | of_L (3) | audio signal |
| 59 | YUV_2_Pr (3) | component- |
| | | video signal |
| 60 | YUV_2_Pb (3) | component- |
| | | video signal |
| 61 | YUV_2_Y (3) | component- |
| | | video signal |
| 62 | Audio_Front_L_R_Gnd_{—} | Europe/US |
| | of_L (3) | audio signal |
| | | common pins |

The exemplification accompanied by drawings below shows that the motherboard 220 assembles an I/O module 210 of various types via the above-mentioned pins of the universal interface 222. As shown in FIG. 2B, in case that the I/O module 210 of the TV set 200 is for receiving an NTSC audio/video signal S_{NTSC}, the decoding/demodulating unit 212 including the US audio/video decoder 213 is for decoding the audio and image parts of the broadcasting signal Sc. Furthermore, the I/O module 210 is coupled to the signal processing unit 224 via the US signal pins 225 and a part of the Europe/US channel common pins 227 of the above-mentioned universal interface 222. As shown in FIG. 2C, in case that the I/O module 210 of the TV set 200 is for receiving the PAL audio/video signals S_{PAL}, the decoding/demodulating unit 212 including the European audio/video decoder 215 is for decoding the audio and image parts of the broadcasting signal Sc. Moreover, the I/O module 210 is coupled to the signal processing unit 224 via the European signal pins 223 and a part of Europe/US channel common pins 227of the universal interface 222.

As shown in FIG. 2D, in case that the I/O module 210 of the TV set 200 is for receiving the ATSC audio/video signals S_{ATSC}, the decoding/demodulating unit 212 including the US audio/video decoder 213 and the digital analog converter 217 is for decoding and converting the audio and image parts of the broadcasting signals Sc into analog signals and then outputting the converted signals. Furthermore, the I/O module 210 is coupled to the signal processing unit 224 via the US signal pins 225 and a part of the Europe/US channel common pins 227 of the universal interface 222.

Besides, as shown in FIG. 2E, in case that the I/O module 210 of the TV set 200 is for receiving the DVB audio/video signals S_{DVB}, the decoding/demodulating unit 212 including the European audio/video decoder 215 and the digital analog converter 219 is for decoding and converting the audio and image parts of the broadcasting signals Sc into analog signals and then outputting the converted signals. Furthermore, the I/O module 210 is coupled to the signal processing unit 224 via the European signal pins 223 and a part of the Europe/US channel common pins 227 of the universal interface 222.

The designer can choose suitable signal group according to user's requirements when designing the interface pins of the I/O module to provide a desired type of TV set. For example, the user may request two sets of CVBS signals and two sets of SVHS signals as the input source of the baseband audio/video signals. In the meanwhile the function of receiving and demodulating NTSC programs should be provided. Therefore, the I/O module 210 at least needs two sets of CVBS signal pins, two sets of SVHS signal pins, pins of controlling signals USDA and USCL, pins of detecting signals ID_1 and ID_2, audio signals Audio_L and Audio_R, and power pins of +5V and +12V. The microprocessor 226 uses an appropriate control method to complete the functions defined by the TV set according to the status and configuration of the I/O module 210 obtained from the voltage level of the pins of ID_1 and ID_2.

In order that the user can add the function of receiving ATSC digital signals and two sets of component-video signals YPbPr for HDTV by replacing the I/O module 210 after having purchased the TV product, the designer only needs to re-design a new I/O module 210 which can transmit controlling signals RX_232, TX_232, and two sets of YUV signals to the motherboard 220 in addition to the above-mentioned 6 sets of signals and power signals.

According to the above-mentioned preferred embodiment, the TV set of the invention has two advantages:

Firstly, the TV set of the invention modularizes the decoding and demodulating functions which vary with the systems as well as the input/output function of the baseband audio/video signals which varies according to user's needs, and separates the module formed thereby from the motherboard. The separated module is incorporated with the motherboard including a universal interface having power pins and the required pins for receiving signals of various systems such as NTSC, PAL, ATSC and DVB, so the user can select the required type of I/O modules for receiving broadcasting signals and input audio/video signals of different systems, thereby the system upgrade ability of the TV set.

Secondly, since the I/O module has been separated from the motherboard, the designer can change the I/O module to create various TV models without changing the TV exterior design and the motherboard. Furthermore, owing that the motherboard can be used again as the I/O module is renewed, the stocks can be largely reduced. For example, when incorporated with suitable I/O modules, the ten thousand pieces of motherboards currently stored in Taiwan can be assembled to various TV models and sold to US or European nations for receiving TV channel signals of European or US systems, thereby increasing the flexibility of production management.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A TV set, for receiving an input signal, comprising:
an extended module, for decoding and demodulating the input signal and outputting a baseband audio/video signal accordingly; and
a motherboard, comprising:
a universal interface, for coupling with the extended module and receiving the baseband audio/video signal;
a signal processing unit, for coupling with the universal interface, doing audio/video processing on the baseband audio/video signal and then outputting the processed signal; and
a microprocessor, for controlling the signal processing unit and controlling the extended module via the universal interface.

2. The TV set according to claim 1, wherein the input signal comprises a broadcasting signal and a plurality of baseband audio/video signals.

3. The TV set according to claim 2, wherein the extended module comprises a decoding/demodulating unit and a multiplexer, the decoding/demodulating unit decodes and demodulates the broadcasting signal, and the multiplexer selects a part of the baseband audio/video signals for the output.

4. The TV set according to claim 3, wherein the microprocessor uses the universal interface to directly detect and control the decoding/demodulating unit and the multiplexer.

5. The TV set according to claim 3, wherein the extended module comprises a controller, and the microprocessor obtains the status of the extended module and indirectly controls the decoding/demodulating unit and the multiplexer through the controller via the universal interface by polling method.

6. The TV set according to claim 3, wherein the universal interface comprises a plurality of European signal pins, a plurality of US signal pins, and a plurality of Europe/US channel common pins.

7. The TV set according to claim 6, wherein the input signal is an NTSC audio/video signal, the decoding/demodulating unit comprises a US audio/video decoder, and the extended module uses the US signal pins and a part of the Europe/US channel common pins of the universal interface to couple with the signal processing unit.

8. The TV set according to claim 6, wherein the input signal is a PAL audio/video signal, the decoding/demodulating unit comprises an European audio/video decoder, and the extended module uses the European signal pins and a part of the Europe/US channel common pins of the universal interface to couple with the signal processing unit.

9. The TV set according to claim 6, wherein the input signal is an ATSC audio/video signal, the decoding/demodulating unit comprises a US audio/video decoder and a first digital analog converter, and the extended module uses the US signal pins and a part of the Europe/US channel common pins of the universal interface to couple with the signal processing unit.

10. The TV set according to claim 6, wherein the input signal is a DVB system signal, the decoding/demodulating unit comprises an European audio/video decoder and a second digital analog converter, and the extended module uses the European signal pins and a part of the Europe/US channel common pins of the universal interface to couple with the signal processing unit.

11. The TV set according to claim 6, wherein the European signal pins comprise a plurality of the teletext signal pins and a plurality of the SCART signal pins, the US signal pins comprise a plurality of first audio signal pins, and the Europe/US channel common pins comprise a plurality of video signal pins, a plurality of component-video signal pins, a plurality of controlling signal pins, a plurality of the detecting signal pins, a plurality of power pins and a plurality of second audio signal pins.

12. The TV set according to claim 11, wherein the extended module comprises a DVD decoder for decoding a DVD audio/video signal, while the microprocessor uses the detecting signal pins to detect the DVD decoder and uses the controlling signal pins to control the DVD decoder.

13. The TV set according to claim 1, wherein the signal processing unit is for doing basic video, image and audio processing on the baseband audio/video signal.
